(19) United States
(12) Patent Application Publication
(10) Pub. No.: US 2016/0104240 A1
(43) Pub. Date: Apr. 14, 2016

(54) Trading Platform

(71) Applicant: Matthew Hesterberg, New York, NY (US)

(72) Inventor: Matthew Hesterberg, New York, NY (US)

(21) Appl. No.: 14/882,153

(22) Filed: Oct. 13, 2015

Related U.S. Application Data
(60) Provisional application No. 62/063,847, filed on Oct. 14, 2014.

(51) Int. Cl. G06Q 40/04

(52) U.S. Cl. CPC G06Q 40/04

(57) ABSTRACT

A system and methods that connect parties that are truly axed on opposite sides of a trade, thereby providing investors with the most competitive price while increasing efficiency and reducing transaction costs.

### FIELD OF THE INVENTION

The present invention relates generally to a centralized system for buying and selling various types of securities.

### BACKGROUND OF THE INVENTION

Numerous software-based systems exist for the trading of securities. Such systems have the advantage of efficiently facilitating transactions as well as the ability to connect buyers and sellers from all over the world. These systems can facilitate transactions between dealers in a certain security, such as banks that are in the business of buying and selling a particular security, and institutional investors such as asset managers, insurance companies, pensions, hedge funds, etc. Often, transactions between a dealer and an institutional investor will be predicated upon an “axe” of one or both of the parties, i.e., an indication of interest that a particular party has in buying or selling a particular security.

In a traditional scenario, an investor will ask market-making dealers for bids or offers when the investor wants to sell or buy, respectively, a given security. How the investor determines which market-making dealers to ask has historically been based on a number of factors, including but not limited to the dealer's name, reputation, or past aggressiveness in pricing; the investor's relationship with their sales coverage at a particular dealer; the quality and amount of research provided by a given dealer; or just that it happens to be a particular dealer's turn (most institutional investors prefer to spread their business among various dealers in order to maintain a good relationship with as many dealers as possible and to prevent any single dealer from learning fully an investors investment strategy), etc. After the investor has determined which dealers to approach, the investor may poll these dealers for their axes, and then attempt to trade with those dealers who have indicated interest in taking the opposite side of the trade that the investor is looking to do. Even in this scenario, the investor surely has not asked all dealers and many of the dealers' claimed axes may not be legitimate. This polling process also takes time when many traders prefer or need to act quickly.

In addition, investors often will trade with dealers who may not actually want to take the other side of the transaction, but will do so with the aim of simply passing off the trade to another investor with, of course, the intention of making a profit. This unnecessarily adds cost to the transaction, as there may have been other dealers who would have been truly axed on the other side of the trade but were not contacted by the investor for one reason or another. This is often the result of the investor only contacting the top-tier dealers while ignoring second, third and fourth-tier dealers. Further, traditionally, dealers have only been able to trade with each other through the broker market, thus inserting additional middlemen and additional cost, while also reducing anonymity.

Accordingly, there is a need in the art for a system that connects parties that are truly axed on opposite sides of a trade, thereby providing investors with the most competitive price while increasing efficiency and reducing transaction costs. There is also the need in the art for a system which gives all dealers, regardless of tier, a chance to compete for the business they truly want to do with institutional investors.

### SUMMARY OF THE INVENTION

The present invention is directed to a method of trading securities comprising the steps of:

(a) receiving an axe for a security from a first user;
(b) posting the axe of the first user without disclosing the identity of the first user;
(c) receiving an indication from a second user to take a certain direction in a trade for the security.
(d) transmitting an anonymous trade inquiry for the security to the first user if the axe of the first user is in an opposite direction of the direction in the trade indicated by the second user;
(e) receiving a response to the trade inquiry from the first user; and
(d) processing a trade between the first user and second user for the security through a central intermediary party.

Generally, the first party will be a dealer in the particular security and the second party will be an investor (generally an institutional investor) or an end user. However, it is also contemplated that the first party is an investor and the second party is a dealer, or that the first and second party are both dealers or both investors.

The central intermediary party acts as a counterparty to both the first and second user to ensure anonymity. Thus, for example, if the first user is axed as a seller of a particular security and the second user is axed as a buyer of a particular security, when the trade is processed, the second user will not transfer payment directly to the first user and the first user will not transfer ownership of the security directly to the second user. Rather, the second user will transfer payment and the first user will transfer ownership of the security to the central intermediary party. The central intermediary party will thereafter transfer the payment to the first user and ownership of the security to the second user or vice versa. Often, the central intermediary party will be the same party that controls and operates the system on which axes are received and posted.

The present invention is also directed to a method having the optional additional step after the trade is processed of sending an inquiry to the first and second user to determine if both the first and second user would be willing to transact an additional quantity of the trade just processed on the same terms, and processing an additional trade through the central intermediary party if both the first and second user assent to the additional quantity of the trade.

The present invention is additionally directed to a method in which, if the first user or second user does not assent to the trade, a counteroffer to the trade may be transmitted to the other user. In this embodiment, the method may further comprise transmitting a counter to the counteroffer, at which time the first and second users may enter into an exclusive negotiation.

### DETAILED DESCRIPTION

The methods of trading securities of the present invention are different from traditional trading platforms because it gives investors a method for trading anonymously and exclusively with counterparties who have expressed an interest in taking the other side of a trade the investor is trying to make. This protects the identity of a particular investor and the sensitive nature of the exact trade they are trying to do. More importantly, it should help the investor get the trade done at a better price. The platform of the present invention is suitable for the trading of any type of security, including but not limited to, government bonds, corporate bonds and equities.

The platform of the present invention may have separate interfaces depending on whether a user identifies itself as a dealer or an investor. As used herein, an investor may sometimes be referred to as an “institutional investor” or an “end user.”

In an embodiment of the present invention, prior to the day's trading, a dealer in a particular security will post its axes, i.e., the securities they truly want to buy or sell. This would begin during a “loading phase” where dealers could start posting their axes prior to the platform opening for business. Dealers preferably will not be made aware of the posted axes of other dealers or the amount of dealers posting the same axe. Dealers may also be permitted to post axes after the platform is open for trading.

In one embodiment of the present invention, once the platform is open for trading, which will occur at a pre-determined time, such as 8 am Eastern Standard Time, posted axes may be removed from the system after a minimum waiting period, such as between about 10 minutes and 2 hours, preferably between about 30 minutes and 1 hour, most preferably about 1 hour. In an alternative embodiment, there is no waiting period to remove an axe. In another embodiment, after an axe has been removed by a dealer, the dealer is prevented from posting an axe in the same security in the opposite direction of the removed axe until after a minimum waiting period, such as between about 10 minutes and 2 hours, preferably between about 30 minutes and 1 hour. The minimum waiting period may also be a predetermined time of day, such as 1 pm Eastern Standard Time, or a combination of a period of time and time of day, e.g., the minimum waiting period is 1 hour or 1 pm EST, whichever is sooner. In embodiments where a time of day is used for the minimum waiting period, such as 1 pm EST, axes removed after 1 pm preferably could not be reversed until after the close of the platform at the end of the day, which also may be a preset time, such as 5 pm Eastern Standard Time.

The direction of a dealer's axe may be recorded in a database which interrelates axes and dealers. Thus, in a preferred embodiment, before a dealer is authorized to post an axe, the database is queried to determine if the dealer had previously posted an axe in the opposite direction prior to the expiration of the minimum waiting period, and if so, the dealer may be blocked from posting the axe until the expiration of the minimum waiting period.

As used herein, an axe is “posted” when it is received in a computer processor via a network from a user, such as a dealer, and stored in a memory location of a computer system, such as in a database, for subsequent trading.

In an embodiment of the present invention, dealers on the platform are only able to post a limited number of axes or different securities at a single time, such as 25, 50, 75, 100, 125, 150, 175 or 200.

In an embodiment of the present invention, dealers are restricted to certain size buckets. In this embodiment, in order to trade in a larger size bucket, the dealer preferably must have transacted a minimum amount in a smaller size bucket. As used herein, a “bucket” refers to a group of securities having a specified value range.

In a preferred embodiment, which could be employed for nominal U.S. Treasuries for example, a dealer is limited to 75 axes, which may be distributed as, for example: 25 axes in a <50 million bucket, 20 axes in a 50 million to <200 million bucket, 15 axes in a 200 million to <500 million bucket, 10 axes in a 500 million to <1 billion bucket, and 5 axes in a 1 billion or greater bucket.

For certain securities, such as U.S. Treasuries, axes may be in sectors or maturity ranges. Thus, the sector axes could be for a maturity of 1 month or less, >1 month to 3 months, >3 months to 6 months, >6 months to 1 year and >1 year to 18 months, In this embodiment, a dealer may post an axe as a certain maturity date range rather than a certain issue.

In an alternative preferred embodiment of the present invention, dealers are permitted to choose a limited number of securities (along with a direction for each) that they are significantly axed to transact in. This guarantees the dealers a chance to compete for any trade inquiries transmitted through the platform for those securities, and in the direction, chosen by the dealer. In an embodiment of the present invention, dealers are also permitted to choose a limited number of securities to be “odd-lot” axed in, which will permit the dealer to conduct smaller trades in the dealer's “odd-lot” securities, but not bigger trades. The number of “odd-lot” trades the dealer can be axed in is preferably capped at a greater amount than the number of securities dealers are permitted to be significantly axed in. In this embodiment, there are no size buckets other than the “odd-lot” axes and axes that are greater than the cut-off for “odd-lot” axes, i.e., true axes. A person skilled in the art could easily determine a suitable cut-off for distinguishing odd-lot and true axes.

“Odd-lot” sized axes would allow dealers an opportunity to clean up their smaller positions over the platform without having to waste one of their axes on a small position. When posting an axe, the system preferably would prompt a dealer to input whether the axe was a true axe, of which they will only have a limited number as mentioned above, or merely an odd-lot clean up axe, of which they will preferably be allowed a greater number. The system would then receive the dealers input and determine whether the dealer should be placed in a pool with true axes or odd-lot axes. Thus, for example, if a dealer is an odd-lot axed buyer, it preferably would only see inquiries from the odd-lot axed sellers.

In a preferred embodiment of the present invention, dealers must be displaying an axe in the correct direction before they could see a trade inquiry in that security from an end user. For multi-leg inquiries (curves, butterflies, for example) dealers preferably need only be axed in one leg of the trade in order to see the inquiry.

In another preferred embodiment of the present invention, an end user does not post axes the way dealers do, but if there is a security that does not have a 2-way axe posted on the end user's version of the platform, the end user may initiate the transmittal of an “axe request” to the dealer community in that security. Dealers may then choose whether to post an axe in that security. After the dealers have responded to the “axe request” in a particular security, by posting an axe in that security or not, should a 2-way axe picture now exist, the end user preferably would be expected to send a trade inquiry to the dealers axed in the correct direction. If an end user fails to attempt to trade following an axe request that results in a 2-way axe in a particular security, the end user's ability to send axe requests may be restricted in order to protect users from parties just seeking information rather than trying to trade. Such a restriction may be accomplished by placing an indicator in the computer memory or storage, such as a computer database, that the particular end user has restricted usage of the platform. Preferably, end users will be able to see whether or not any dealers are axed in a given security, but they will not see the number of dealers axed in total. In other embodiment of the present invention, end users will be able to see within which size buckets dealers are posting axes or whether dealers are posting “odd-lot” or true axes, but will not see the total number of dealers relating to each.

In another preferred embodiment, an end user may initiate a trade inquiry that is then transmitted to only the dealers “axed” to take the other side of the trade that the end user wishes to take. Should a particular end user require a minimum number of dealers to provide it with prices, the end user may initiate a setting which prevents the end user from submitting a trade inquiry until its chosen minimum number of dealers have posted axes on the other side of the trade. In an embodiment of the present invention, end users may also indicate by a setting whether they want all dealers axed in the correct direction in the security to see their trade inquiry, or if only those dealers axed in the correct direction as well as in the same and larger size buckets to see it. Such settings may be stored in computer memory or storage, such as a computer database, preferably in a location that is interrelated with the end user.

Any dealer receiving a trade inquiry should be especially interested in taking the other side of an institutional investor's trade given that the dealer has specifically chosen that particular security as one of its posted axes. The dealer should also know that any other dealers who see the trade inquiry will also be axed to do the trade. This will encourage the dealers to be as aggressive as possible, which will lead to better pricing for buy side accounts (end users) while ensuring that dealers see the trades they are actually interested in making, as opposed to their traditional market making role in which they entertain trades that they are merely willing to do.

In response to a trade inquiry, a dealer may auto-quote a price via the platform of the present invention in order to more quickly respond. The system preferably would contain an optional setting which allows the dealer to auto-quote at their published market price for a particular security or to auto-quote at a price that is better than their current market price for a particular security. When auto-quoting at better prices, the system preferably would enable a dealer to input a suitable increment for the auto-quote, such as increments of 1 cent in the case of stocks or sixteenths of a 32^{nd} in the case of U.S. Treasuries. The system of the present invention may also allow a dealer to configure different levels of auto-quotes based on the size range of a trade inquiry.

In another aspect of the present invention, dealers may use the platform similarly to institutional investors to trade with other dealers who are axed oppositely. To prevent abuse, the system preferably will monitor and maintain a record in memory or storage, such as a database, the volume of transactions a dealer has conducted with institutional investors. This data may be used to prevent a dealer from initiating a trade inquiry to another dealer unless the dealer has reached a certain minimum volume of transactions with institutional investors on the platform. Also to prevent abuse, the system preferably will block dealers from viewing posted axes of other dealers in the manner that other end users do. In addition, dealers who receive a trade inquiry from another dealer preferably will be informed via a notification received through the platform that the trade inquiry originated from another dealer, as opposed to an end user. This, understandably, may impact a dealer's aggressiveness in pricing dealer RFQs.

In a further embodiment of the present invention, end users may also transact with dealers over the platform without sending a trade inquiry. In this embodiment, the end user may simply enter the trade it would like to do (security, direction, size, settlement and price/yield/yield spread/discount), indicate whether the trade should only be available to dealers within the same and greater sized buckets, and indicate whether partial fills will be accepted (and if so, the minimum size). Upon submitting the trade specifications via the platform, the trade parameters may be sent to oppositely axed dealers. The platform preferably will notify the dealers simultaneously, such as via a system notification message, text or email, with the trade details and provide each dealer with the option to accept the trade, pass on the trade or present a counteroffer to the end user.

End users receiving a counteroffer preferably will similarly receive an alert with the same three options, and selecting counteroffer in this instance will enter the dealer and the end user into an exclusive negotiation. A trade may be processed between an end user and the first dealer to accept the trade proposed by the end user. In the event of an exact tie, the platform preferably would split the trade among the dealers which tied based on the amount they are trying to trade. If the end user indicated that partial fills are acceptable, the platform preferably will permit multiple dealers to accept the trade until the end user's trade is filled.

The platform is preferably configured so that if a bid or offer is not filled within a certain amount of time it will expire. After a completed trade, the platform may also provide the dealer with the opportunity to continue to be axed in the particular security that traded, and in embodiments where dealers are restricted to certain bucket sizes, also provide the dealer with an opportunity to change bucket sizes.

In certain aspects of the present invention, after a trade has been processed, preferably immediately after, the parties involved in the trade may be notified, such as via a system notification message, text or email, that they have the option to attempt to transact more of the same trade. The notification may also request input from the user as to whether it would like to proceed with more of the same trade. In a preferred embodiment of the present invention, the notification may also request input from each party as to the quantity of the particular security in question that the party would be willing to trade more of. This input can be requested as part of the original notification message or can be requested by a separate notification message after the party has assented to proceeding with more of the same trade.

Regardless of when the request for user input as to quantity occurs, the party receiving the request preferably must provide input within a defined time, such as 1-60 seconds, preferably 2-30 seconds and most preferably 3-20 seconds or 5, 10 or 15 seconds, or else the opportunity to transact more of the same trade will be withdrawn. If a party declines to transact more of the same trade or does not provide input within the allotted time, the platform preferably will not disclose whether the other party to the original transaction assented to trading more in order to prevent abuse. If both sides to the original transaction assent to trading more, the platform may process the trade but preferably only at the smaller of the quantities that were previously indicated as acceptable by the parties. The process of offering the opportunity for more trading of the same security on the same terms can be repeated over again until at least one of the parties no longer assents to more trading.

The platform may also track the trading habits of its users, which is stored in memory or storage, such as a computer database, to determine potential abuses. Thus, the present invention also relates to a method of detecting abuses in a system for trading securities comprising the steps of:

(a) receiving an axe of a user for a security;
(b) retrieving a previous axe of the user for the same security from a storage location;
(c) calculating a difference between a first time the axe was received and a second time the previous axe was received;
(d) determining if the axe and the previous axe are in opposite directions.
(e) blocking storage of the axe to the storage location if the difference is less than a predefined minimum waiting time and if the axe and previous axe are in opposite directions.
Thus, in this embodiment, the storage location is preferably a database with interrelated tables, one such table containing axes and a schema that preferably includes at a minimum the time an axe was received, the direction of the axe, the security the axe relates to and the user for which the axe corresponds.

The platform of the present invention relies on speedy execution of trades. To encourage speedy trades and to prevent abuse, requests to trade preferably will have to be at a price within a certain fair range for that security's current market price. Certain quantities of certain securities may call for a trading price that is further away from what the generally accepted current market price of the security may be. However, this will be limited by the fact that the only possible counterparty one may have is someone who is axed in the opposite direction. Also, if the proposed price is outside of a certain range, then the system may provide notice of this fact on notification of the trade inquiry. Further, if a proposal is for an “outright” trade, a user can protect itself from market movement by linking the proposed price to a yield spread to where the current relevant benchmark is trading.

The functions described herein are implemented in software in one embodiment. The software comprises computer executable instructions stored on computer readable media such as memory or other type of storage devices. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

In a preferred embodiment of the present invention, certain data is stored in a storage location. Preferably, the storage location is a database containing one or more interrelated tables. The data preferably includes information on users such as name, address, phone number, bank account information, type of user, e.g., investor or dealer, preferences of the user, such as the minimum number of oppositely axed users required to send a trade inquiry, and any restrictions on the user's ability to access the platform or make trades, as well as information on axes, such as the user the axe is associated with, the time the axe was posted, the time the axe was removed, the security the axe relates to, the direction of the axe, i.e., buyer or seller, financial information relating to the security such as size, settlement and price/yield/yield spread/discount, any counteroffers and whether the axe resulted in a trade. In addition, data can be stored which identify various variable parameters, such as minimum waiting time to remove an axe, minimum waiting time to reverse the direction of an axe, the size ranges of the buckets, etc.

Preferably a separate database table is maintained for users and axes and optionally counteroffers. Moreover, it should also be understood that each of the data described above that is collected for users and axes can also be maintained on a separate database table which is interrelated with the user table or the axe table.

The computer system of the present invention may contain a central processing unit (CPU) that executes computer programs stored on a memory. Memory in one embodiment comprises one or more levels of cache as desired to speed execution of the program and access to data on which the programs operate. The CPU is directly coupled to memory with both CPU and memory coupled to a bus. A storage, I/O and communications are also coupled to the bus. Storage is usually a long term storage device, such as a disk drive, tape drive, DVD, CD or other type of storage device.

In one embodiment, storage is used to house a database for use with the present invention. I/O comprises keyboards, sound devices, displays and other mechanisms by which a user interacts with the computer system. Communications comprises a network, phone connection, local area network, wide area network or other mechanism for communicating with external devices. Such external devices comprise servers, other peer computers and other devices. In one embodiment, such external device comprises a database server that is used in place of the database on storage.

Other computer system architectures capable of executing software and interacting with a database and users may also be used. Additionally, appropriate security measures such as encryption are used to ensure confidentiality and data integrity and backup measures are used to prevent data loss.

An embodiment of the present invention employs a computer system for use in a method of trading securities comprising the steps:

(a) receiving an axe for a security from a first user in one or more computer processors and storing the axe in one or more computer databases;
(b) receiving an indication to take a certain direction in a trade for the security by a second user in one or more computer processors and storing the indication in one or more memory locations or one or more computer databases;
(c) querying the one or more databases storing the axe of the first user to determine if the axe of the first user is in an opposite direction of the direction in the trade indicated by the second user;
(d) transmitting a trade inquiry to the first user via a network only if the axe of the first user is in the opposite direction of the direction in the trade indicated by the second user;
(e) receiving a response to the trade inquiry from the first user in the one or more computer processors; and
(f) processing with the one or more computer processors a trade between the first user and the second user for the security through a central intermediary party.

The system above describes a transaction between a single first user and single second user. However, it should be understood that it is likely that multiple “first users” will transmit an axe in the same direction for the same security and thus the system described above can be adapted to accommodate multiple first users.

In a preferred embodiment, a trade inquiry is initiated by an end user and received in a computer processor of the platform. In embodiments of the present invention, the trade inquiry is a request for quote (“RFQ”).

In a preferred embodiment, the response to the trade inquiry is selected from an instruction to trade, an instruction to decline, an instruction to counteroffer or an instruction to present a price quote.

A further embodiment of the present invention employs a computer system in a method of trading securities comprising the steps:

(a) receiving one or more axes in a security in one or more computer processors and storing the one or more axes in one or more computer databases;
(b) receiving in one or more computer processors an indication to take a certain direction in a trade for a security from a user and storing the indication in one or more memory locations or one or more computer databases;
(c) querying the one or more computer databases storing the axes to return axes in the security that are in the opposite direction of the direction in the trade indicated by the user, said axes corresponding to one or more additional users;
(d) transmitting to the user a list of axes returned by the query via a network without identifying the additional user associated with the axe or identifying the total number of axes returned by the query;
(e) transmitting a trade inquiry initiated by the user to the additional users corresponding to the axes.

In an embodiment of the present invention, the above method may additionally include the steps of receiving in the one or more computer processors one or more responses to the trade inquiry from any or all of the additional users and transmitting the one or more responses to the user via a network. In a preferred embodiment, the response may contain a price quote for the security. Additionally, the above method may further include the steps of receiving a response from the user which accepts or declines the responses of the additional users and processing a trade for the security between the user and an additional user for whom the user accepted its response. In this embodiment, the user can only accept the response of one additional user.

The present invention additionally relates to a computer system having one or more processors and one or more storage locations, such as a physical memory storing a computer database, which is equipped to compute and process any of the methods described herein.

In a preferred embodiment of the present invention, users are given ratings, which are preferably stored in a database. The ratings may be based on how often and/or how much the user trades, whether the user posts axes and removes them immediately after a minimum waiting period, whether the user posts axes and them submits an axe in the opposite direction after a minimum waiting period, and/or whether the user submits many axes but rarely if ever trades. The user's rating may be used to determine membership fees, fees for commission on trades, or whether the user is abusing the system which can result in suspension from the system or notification to the authorities.

It is envisioned that any feature or element that is positively identified in this description may also be specifically excluded as a feature or element of an embodiment of the present invention as defined in the claims.

The invention described herein may be practiced in the absence of any element or elements, limitation or limitations which is not specifically disclosed herein. Thus, for example, in each instance herein, any of the terms “comprising,” “consisting essentially of” and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the claims.

1. A method of trading securities over a computer network comprising the steps:
(a) receiving an axe for a security from a first user in one or more computer processors and storing the axe in one or more computer databases;
(b) receiving an indication to take a certain direction in a trade for the security by a second user in one or more computer processors and storing the indication in one or more memory locations or one or more computer databases;
(c) querying the one or more databases storing the axe of the first user to determine if the axe of the first user is in an opposite direction of the direction in the trade indicated by the second user;
(d) transmitting a trade inquiry to the first user via a network only if the axe of the first user is in the opposite direction of the direction in the trade indicated by the second user;
(e) receiving a response to the trade inquiry from the first user in the one or more computer processors; and
(f) processing with the one or more computer processors a trade between the first user and the second user for the security through a central intermediary party.

2. The method of claim 1 comprising more than one first user.

3. A method of trading securities over a computer network comprising the steps:
(a) receiving one or more axes in a security in one or more computer processors and storing the one or more axes in one or more computer databases;
(b) receiving in one or more computer processors an indication to take a certain direction in a trade for a security from a user and storing the indication in one or more memory locations or one or more computer databases;
(c) querying the one or more computer databases storing the axes to return axes in the security that are in the opposite direction of the direction in the trade indicated by the user, said axes corresponding to one or more additional users;
(d) transmitting to the user a list of axes returned by the query via a network without identifying the additional user associated with the axe or identifying the total number of axes returned by the query;
(e) transmitting a trade inquiry initiated by the user to the additional users corresponding to the axes.

4. The method of claim 3 further comprising the steps of receiving in the one or more computer processors one or more responses to the trade inquiry from any or all of the additional users and transmitting the one or more responses to the user via a network.

5. The method of claim 4 wherein the response contains a price quote for the security.

6. The method of claim 3 further comprising the steps of receiving a response from the user which accepts or declines the responses of the additional users and processing a trade for the security between the user and an additional user for whom the user accepted its response.

7. A method of trading securities over a computer network comprising the steps of:
(a) receiving an axe for a security from a first user;
(b) posting the axe of the first user without disclosing the identity of the first user;
(c) receiving an indication from a second user to take a certain direction in a trade for the security.
(d) transmitting, via an alert, an anonymous trade inquiry for the security to the first user if the axe of the first user is in an opposite direction of the direction in the trade indicated by the second user;
(e) receiving a response to the trade inquiry from the first user; and
(d) processing a trade between the first user and second user for the security through a central intermediary party.

8. The method of claim 7 further comprising the step (e) of sending an inquiry, via an alert, to the first and second user seeking the authorization of both the first and second user to transact an additional quantity of the trade just processed on the same terms, and (f) processing an additional trade through the central intermediary party if both the first and second user authorize the additional quantity of the trade.

9. (canceled)
